(19) United States
(12) Patent Application Publication
(10) Pub. No.: US 2026/0223902 A1
(43) Pub. Date: Aug. 6, 2026

(54) METHOD FOR IMPROVING EATING QUALITY OF FOOD

(71) Applicant: AJINOMOTO CO., INC., Tokyo (JP)

(72) Inventors: Nobuhito NAGAO, Kawasaki-shi (JP); Mikako TOKUDA, Kawasaki-shi (JP)

(73) Assignee: AJINOMOTO CO., INC., Tokyo (JP)

(21) Appl. No.: 19/631,336

(22) Filed: Mar. 27, 2026

Related U.S. Application Data
(63) Continuation of application No. PCT/JP2024/034336, filed on Sep. 26, 2024.

(30) Foreign Application Priority Data
Sep. 29, 2023 (JP) 2023-170704

(51) Int. Cl. A23L 27/26; A23L 27/21; A23L 31/15

(52) U.S. Cl. CPC A23L 27/26; A23L 27/21; A23L 31/15

(57) ABSTRACT

Eating quality of foods is improved by blending γ-glutamyl-2-aminobutyric acid (γ-Glu-Abu) and lysine.

### CROSS REFERENCE TO RELATED APPLICATIONS

This application is a continuation of International Application No. PCT/JP2024/034336, filed on Sep. 26, 2024, which claims priority to Japanese Patent Application No. 2023-170704, filed on Sep. 29, 2023. The entire contents of the above-identified applications are incorporated herein by reference.

### TECHNICAL FIELD

The present invention relates to a technique for improving eating quality of foods.

### BACKGROUND ART

Foods such as consommé contain livestock meat extracts such as beef extract. In recent years, reducing the amount of such livestock meat extracts, including beef extract, has become important to ensure stable raw material supply, reduce costs, and accommodate diverse consumer preferences. However, no known method compensates for the resulting decline in eating quality, such as kokumi and flavors derived from beef extract.

Patent document 1 discloses impartation of kokumi using γ-glutamyl-2-aminobutyric acid (γ-Glu-Abu).

Patent document 2 discloses enhancement of retronasal aroma using γ-Glu-Abu.

Patent document 3 discloses impartation of initial taste type kokumi using a combination of a γ-glutamyl peptide selected from γ-Glu-X-Gly (where X represents an amino acid or amino acid derivative) and γ-Glu-Y (where Y represents an amino acid or amino acid derivative), and a dicarboxylic acid selected from L-tartaric acid and adipic acid.

Patent document 4 discloses impartation of deliciousness to reduced-salt foods and beverages using vegetable protein hydrolysate and yeast extract. Patent document 4 also discloses further addition of amino acids (including lysine).

Patent document 5 discloses a saltiness enhancer containing a basic amino acid, basic amino acid hydrochloride, and acidic substance at specific concentrations.

### PRIOR ART REFERENCES

### Patent Documents

Patent document 1: WO2010/114022
Patent document 2: Japanese Patent Publication (Kokai) No. 2020-191818 (JP 2020-191818 A)
Patent document 3: Japanese Patent Publication (Kokai) No. 2022-010350 (JP 2022-010350 A)
Patent document 4: Japanese Patent Publication (Kokai) No. 2011-004668 (JP 2011-004668 A)
Patent document 5: Japanese Patent Publication (Kokai) No. 2017-135996 (JP 2017-135996 A)

### SUMMARY OF THE INVENTION

An object of the present invention is to provide a technique for improving eating quality of foods.

The inventor of the present invention found that eating quality of foods can be improved by blending γ-glutamyl-2-aminobutyric acid (γ-Glu-Abu) and lysine, and thus accomplished the present invention.

That is, the present invention can be embodied, for example, as follows.

[1]

A composition for improving eating quality of a food, comprising
γ-glutamyl-2-aminobutyric acid (γ-Glu-Abu) or a salt thereof and lysine or a salt thereof.
   [2]

A composition for producing a food, comprising
γ-glutamyl-2-aminobutyric acid (γ-Glu-Abu) or a salt thereof and lysine or a salt thereof.
   [3]

The composition mentioned above (specifically according to [2]), wherein the food is a food with improved eating quality.

[4]

The composition mentioned above (specifically according to any of [1] to [3]), wherein the lysine or a salt thereof is lysine hydrochloride.

[5]

The composition mentioned above (specifically according to any of [1] to [4]), wherein γ-Glu-Abu or a salt thereof is contained in yeast extract.

[6]

The composition mentioned above (specifically according to any of [1] to [5]), wherein said composition further comprises yeast extract.

[7]

The composition mentioned above (specifically according to any of [1] and [3] to [6]), wherein the improving eating quality includes imparting or enhancing kokumi.

[8]

The composition mentioned above (specifically according to any of [1] and [3] to [7]), wherein the improving eating quality includes enhancing livestock-meat-like sensation.

[9]

The composition mentioned above (specifically according to any of [1] to [8]), wherein the food does not comprise livestock meat extract or comprises livestock meat extract at a content of 10% or lower.

[10]

The composition mentioned above (specifically according to any of [1] to [9]), wherein the food does not comprise beef-derived livestock meat extract or comprises beef-derived livestock meat extract at a content of 10% or lower.

[11]

The composition mentioned above (specifically according to any of [1] to [10]), wherein said composition comprises γ-Glu-Abu or a salt thereof and lysine or a salt thereof at a molar ratio of 10:1 to 1:100.

[12]

The composition mentioned above (specifically according to any of [1] to [11]), wherein said composition comprises γ-Glu-Abu or a salt thereof and lysine or a salt thereof at a molar ratio of 1:1 to 1:40.

[13]

The composition mentioned above (specifically according to any of [1] to [12]), wherein said composition comprises γ-Glu-Abu or a salt thereof and lysine or a salt thereof at a molar ratio of 1:6 to 1:12.

[14]

A method for improving eating quality of a food, comprising
the step of adding γ-glutamyl-2-aminobutyric acid (γ-Glu-Abu) or a salt thereof and lysine or a salt thereof to a raw material of the food.
   [15]

A method for producing a food, comprising
the step of adding γ-glutamyl-2-aminobutyric acid (γ-Glu-Abu) or a salt thereof and lysine or a salt thereof to a raw material of the food.
   [16]

The method mentioned above (specifically according to [15]), wherein the food is a food with improved eating quality.

[17]

The method mentioned above (specifically according to any of [14] to [16]), wherein the lysine or a salt thereof is lysine hydrochloride.

[18]

The method mentioned above (specifically according to any of [14] to [17]), wherein γ-Glu-Abu or a salt thereof is contained in yeast extract.

[19]

The method mentioned above (specifically according to any of [14] to [18]), said method further comprising the step of adding yeast extract to a raw material of the food.

[20]

The method mentioned above (specifically according to any of [14] and [16] to [19]), wherein the improving eating quality includes imparting or enhancing kokumi.

[21]

The method mentioned above (specifically according to any of [14] and [16] to [20]), wherein the improving eating quality includes enhancing livestock-meat-like sensation.

[22]

The method mentioned above (specifically according to any of [14] to [21]), wherein the food does not comprise livestock meat extract or comprises livestock meat extract at a content of 10% or lower.

[23]

The method mentioned above (specifically according to any of [14] to [22]), wherein the food does not comprise beef-derived meat extract or comprises beef-derived meat extract at a content of 10% or lower.

[24]

The method mentioned above (specifically according to any of [14] to [23]), wherein γ-Glu-Abu or a salt thereof and lysine or a salt thereof are added at a molar ratio of 10:1 to 1:100.

[25]

The method mentioned above (specifically according to any of [14] to [24]), wherein γ-Glu-Abu or a salt thereof and lysine or a salt thereof are added at a molar ratio of 1:1 to 1:40.

[26]

The method mentioned above (specifically according to any of [14] to [25]), wherein γ-Glu-Abu or a salt thereof and lysine or a salt thereof are added at a molar ratio of 1:6 to 1:12.

[27]

The method mentioned above (specifically according to any of [14] to [26]), wherein γ-Glu-Abu or a salt thereof is added so that final concentration of γ-Glu-Abu or a salt thereof in the food at the time of eating is 0.0001 ppm or higher and 1000 ppm or lower.

[28]

The method mentioned above (specifically according to any of [14] to [27]), wherein γ-Glu-Abu or a salt thereof is added so that final concentration of γ-Glu-Abu or a salt thereof in the food at the time of eating is 0.01 ppm or higher and 1000 ppm or lower.

[29]

The method mentioned above (specifically according to any of [14] to [28]), wherein lysine or a salt thereof is added so that final concentration of lysine or a salt thereof in the food at the time of eating is 0.01 ppm or higher and 1000 ppm or lower.

[30]

The method mentioned above (specifically according to any of [14] to [29]), wherein lysine or a salt thereof is added so that final concentration of lysine or a salt thereof in the food at the time of eating is 0.1 ppm or higher and 1000 ppm or lower.

### EMBODIMENTS FOR CARRYING OUT THE INVENTION

### <1> Active Ingredient

In the present invention, γ-glutamyl-2-aminobutyric acid (γ-Glu-Abu) and lysine are utilized as the active ingredient.

γ-Glu-Abu may be read as γ-Glu-Abu or a salt thereof. Likewise, lysine may be read as lysine or a salt thereof. In other words, in the present invention, γ-Glu-Abu or a salt thereof and lysine or a salt thereof may be utilized as the active ingredient.

By utilizing the active ingredient, eating quality of foods can be improved, i.e., an effect of improving eating quality of foods can be obtained. This effect is also referred to as “eating quality-improving effect”. Improving eating quality of foods is also simply referred to as “improving eating quality”. Specifically, by utilizing the active ingredient, eating quality of foods can be improved compared with when the active ingredient is not utilized. “Not utilizing the active ingredient” may mean not utilizing γ-Glu-Abu and a salt thereof, may mean not utilizing lysine and a salt thereof, or may mean not utilizing both γ-Glu-Abu and a salt thereof as well as lysine and a salt thereof. That is, by utilizing γ-Glu-Abu or a salt thereof and lysine or a salt thereof, eating quality of foods may be improved compared with when γ-Glu-Abu and a salt thereof are not used, when lysine and a salt thereof are not used, or when γ-Glu-Abu and a salt thereof as well as lysine and a salt thereof are not used. Therefore, the active ingredient may be utilized to improve eating quality of foods.

Further, by utilizing the active ingredient, foods with improved eating quality can be produced. Therefore, the active ingredient may be utilized in the production of foods (specifically, production of foods with improved eating quality).

The eating quality includes taste and aroma. That is, by utilizing the active ingredient, taste and/or aroma may be improved. The eating quality may also be referred to as flavor and may mean flavor obtainable at the time of eating. The “aroma” referred to here may mean aroma sensed by the tract from the throat to the nasal cavity at the time of eating foods (i.e., retronasal aroma) and/or aroma directly smelled through the nose (i.e., orthonasal aroma). The “aroma” referred to here may mean, in particular, aroma sensed by the tract from the throat to the nasal cavity at the time of eating foods (i.e., retronasal aroma).

The improvement in eating quality includes enhancement of livestock-meat-like sensation, and impartation or enhancement of kokumi, meat flavor, and oil or fat flavor. The improvement in eating quality includes, in particular, enhancement of livestock-meat-like sensation and impartation or enhancement of kokumi. By utilizing the active ingredient, one type of eating quality alone may be improved, or two or more types of eating qualities may be improved in combination. That is, by utilizing the active ingredient, for example, impartation or enhancement of livestock-meat-like sensation, kokumi, meat flavor, and/or oil or fat flavor may be achieved.

The term “livestock-meat-like sensation” may mean sensation attributable to a raw material derived from livestock meat. Examples of such a livestock meat-derived raw material include livestock meat extracts. That is, in one embodiment, the livestock meat-derived raw material may be read as livestock meat extract. Specifically, the “livestock-meat-like sensation” may mean sensation attributable to the presence of such a meat-derived raw material and sensed at the time of eating a food containing the livestock meat-derived raw material. The term “livestock-meat-like sensation” may be used interchangeably with the term “livestock meat flavor”. The livestock-meat-like sensation includes taste and aroma of livestock meat. Further, livestock-meat-like sensation may be sensed as a combination of kokumi, meat flavor, and oil or fatty flavor derived from livestock meat. The “enhancement of livestock-meat-like sensation” is not limited to increasing livestock-meat-like sensation of foods that inherently have livestock-meat-like sensation (e.g., foods containing livestock meat-derived raw materials), but may also include imparting livestock-meat-like sensation to foods that do not have livestock-meat-like sensation (e.g., foods not containing livestock meat-derived raw materials). For example, by using the active ingredient in combination with a livestock meat-derived raw material, in particular, meat extract, a livestock-meat-like sensation (specifically, an enhanced livestock-meat-like sensation compared with that obtainable when the active ingredient is not utilized) can be imparted to foods not having livestock-meat-like sensation, and the active ingredient alone can also impart livestock-meat-like sensation (specifically, an enhanced livestock-meat-like sensation compared with that obtainable when the active ingredient is not utilized) to foods not having livestock-meat-like sensation.

For example, beef is an example of livestock meat. Meat extract derived from beef is also called beef extract. Beef extract, for example, may be mentioned as an example of the livestock meat-derived raw material. That is, in one embodiment, the livestock meat-derived raw material may be read as beef extract. An example of “livestock-meat-like sensation” is sensation attributable to the presence of beef extract and sensed when eating a food containing beef extract. In this case, livestock-meat-like sensation may be read as beef-extract-like sensation, and enhancement of beef-extract-like sensation may be mentioned as the improvement in eating quality. The beef-extract-like sensation includes taste and aroma of beef extract. Further, the beef-extract-like sensation may be sensed as a combination of kokumi, meat flavor, oil or fat flavor etc. derived from beef extract. The “enhancement of beef-extract-like sensation” is not limited to enhancing beef-extract-like sensation of foods that inherently have beef-extract-like sensation (e.g., foods containing beef extract), but may also include imparting beef-extract-like sensation to foods that do not have beef-extract-like sensation (e.g., foods not containing beef extract). For example, use of the active ingredient in combination with beef extract can impart beef-extract-like sensation (specifically, enhanced beef-extract-like sensation compared with that obtainable when the active ingredient is not used) to foods that do not have beef-extract-like sensation. Furthermore, for example, the active ingredient alone can also impart beef-extract-like sensation (specifically, enhanced beef-extract-like sensation compared with that obtainable when the active ingredient is not used) to foods that do not have beef-extract-like sensation.

The term “kokumi” means a sensation that cannot be expressed by the five basic tastes, i.e., sweet taste, salty taste, sour taste, bitter taste, and umami. Specifically, it may mean a sense of taste constituted not only by the basic tastes, but also by enhanced marginal tastes and marginal flavors of the basic tastes, such as thickness, growth (mouthfulness), continuity, and harmony. In the present invention, the elements constituting kokumi are not particularly limited, but may include, for example, a part or all of the elements of kokumi that is reduced in foods produced with reduced livestock meat-derived raw materials compared with foods containing livestock meat-derived raw materials. More specifically, the elements constituting kokumi referred to in the present invention may include a part or all of the elements of kokumi that is reduced in foods produced with reduced beef extract compared with foods containing beef extract.

The “impartation of kokumi” includes enhancing the basic tastes and concomitantly enhancing or imparting marginal tastes of the basic tastes such as thickness, growth, continuity, and harmony. The “impartation of kokumi” also includes imparting or enhancing flavors such as meat flavor, oil or fat flavor, complexity, aged sensation, richness, livestock-meat-like sensation, milky sensation, fruity sensation, body-like sensation (such as sugar-like body or wine body sensation), and density sensation.

The eating quality (e.g., livestock-meat-like sensation, kokumi etc.) may be categorized into those of initial taste, mid-taste, and aftertaste types. The “initial taste”, “mid-taste”, and “aftertaste” regarding eating quality refer to eating quality sensed from 0 to 1 second, 1 to 3 seconds, and 3 to 5 seconds, respectively, after drinking (after the food is placed in the mouth) in the case of liquids (liquid foods). For solids (solid foods), the “initial taste”, “mid-taste”, and “aftertaste” regarding eating quality refer to eating quality sensed from 0 to 4 seconds, 4 to 10 seconds, and 10 to 15 seconds, respectively, after eating (after the food is placed in the mouth). In the present invention, “solid” refers to a form other than liquid and includes pastes, gels, etc. By utilizing the active ingredient, for example, the initial taste eating quality, mid-taste eating quality, aftertaste eating quality, or a combination thereof may be improved. That is, specifically, by utilizing the active ingredient, for example, initial taste livestock-meat-like sensation, mid-taste livestock-meat-like sensation, aftertaste livestock-meat-like sensation, or a combination thereof may be enhanced. Furthermore, specifically, by utilizing the active ingredient, for example, initial taste kokumi, mid-taste kokumi, aftertaste kokumi, or a combination thereof may be imparted. In particular, by utilizing the active ingredient, not only initial taste kokumi, but also mid-taste kokumi and aftertaste kokumi may be imparted.

The active ingredient may be utilized for improving eating quality or producing foods in the manners described in the section of the method of the present invention described later.

The active ingredient is not particularly limited as long as it contains γ-Glu-Abu or a salt thereof and lysine or a salt thereof. The active ingredient may or may not consist of γ-Glu-Abu or a salt thereof and lysine or a salt thereof. The active ingredient may further contain yeast extract. The yeast extract may contain γ-Glu-Abu or a salt thereof, or may not contain γ-Glu-Abu or a salt thereof. Yeast extract, which contains γ-Glu-Abu or a salt thereof, i.e., yeast extract containing γ-Glu-Abu or a salt thereof, may be utilized instead of γ-Glu-Abu or a salt thereof. In other words, γ-Glu-Abu or a salt thereof may be contained in the yeast extract. That is, the active ingredient may consist of, for example, γ-Glu-Abu or a salt thereof, lysine or a salt thereof, and yeast extract. Alternatively, the active ingredient may consist of, for example, yeast extract containing γ-Glu-Abu or a salt thereof and lysine or a salt thereof.

### (1) γ-Glu-Abu

γ-Glu-Abu is a dipeptide having a structure in which the carboxyl group at the γ-position of glutamic acid (Glu) is peptide-bonded to the amino group of 2-aminobutyric acid (Abu), and is also referred to as γ-glutamyl-2-aminobutyric acid. The γ-Glu-Abu used in the present invention includes any optical isomers.

In the present invention, both the glutamic acid and 2-aminobutyric acid constituting γ-Glu-Abu are L-amino acids, unless especially specified.

As γ-Glu-Abu, a commercially available product or one obtained by appropriately produced may be used. The method for preparing γ-Glu-Abu is not particularly limited and, for example, known methods can be utilized. Examples of such known methods include, for example, a method of chemically synthesizing the peptide or synthesizing the peptide by enzymatic reactions.

When peptides are chemically synthesized, a peptide synthesizer can be used to synthesize or semi-synthesize peptides. Examples of methods for chemically synthesizing peptides include solid-phase peptide synthesis. Synthesized peptides can be purified by conventional means, such as ion exchange chromatography, reverse-phase high performance liquid chromatography, or affinity chromatography. Such solid-phase peptide synthesis and subsequent peptide purification are well known in the art.

When peptides are synthesized by enzymatic reactions, methods such as the method described in WO2004/011653 may be employed. Specifically, a dipeptide or tripeptide can be synthesized by, for example, reacting an amino acid or dipeptide having an esterified or amidated carboxyl group with an amino acid having free amino group (e.g., amino acid having a protected carboxyl group) in the presence of a peptide-producing enzyme. The synthesized dipeptide or tripeptide can be purified as appropriate. Examples of the peptide-producing enzyme include cultures of microorganisms having an ability to produce peptides, culture supernatants separated from such cultures, microbial cells separated from such cultures, cell processed products of such microorganisms, and peptide-producing enzymes separated from these. Appropriately purified peptide-producing enzymes may also be used as required.

γ-Glu-Abu can also be produced by, for example, culturing a microorganism capable of producing γ-Glu-Abu and recovering γ-Glu-Abu from the culture medium or the microbial cells. Specifically, γ-Glu-Abu-containing yeast can be obtained by, for example, the method described in Japanese Patent Publication No. 2012-213376 or WO2012/046731. Further, γ-Glu-Abu can also produced by, for example, recovering it from agricultural, aquatic, or livestock products containing γ-Glu-Abu.

γ-Glu-Abu may or may not be a purified product. That is, a material containing γ-Glu-Abu at a high content may be used as γ-Glu-Abu. “Containing γ-Glu-Abu at a high content” means that the γ-Glu-Abu content is 100 ppm (w/w) or higher. That is, “blending (adding) γ-Glu-Abu” is not limited to blending (adding) γ-Glu-Abu itself, but also includes blending (adding) a material containing γ-Glu-Abu at a high content. Specific examples of such a material containing γ-Glu-Abu at a high content include fermentation products such as culture broth obtained by culturing a microorganism capable of producing γ-Glu-Abu, cells of such a microorganism, and culture supernatant similarly obtained; agricultural, aquatic, and livestock products containing γ-Glu-Abu; and processed products thereof. Such processed products include those obtained by subjecting such fermentation products as mentioned above to such a process as concentration, dilution, drying, fractionation, extraction, and purification. Examples of such processed products include yeast extracts containing γ-Glu-Abu (Japanese Patent Publication No. 2012-213376 or WO2012/046731). Yeast extract containing γ-Glu-Abu, i.e., γ-Glu-Abu-containing yeast extract, is as described later. γ-Glu-Abu may be purified to a desired degree. For example, γ-Glu-Abu may be used at a purity of 50% (w/w) or higher, 70% (w/w) or higher, 90% (w/w) or higher, or 95% (w/w) or higher.

### (2) Lysine

Lysine may be D-lysine, L-lysine, or a mixture thereof, unless especially noted. The ratio of D-lysine and L-lysine in such a mixture is not particularly limited. The ratio of D-lysine or L-lysine in such a mixture may be, for example, 20 to 80%, 30 to 70%, 40 to 60%, or 45 to 55% in terms of molar ratio. Lysine may be, in particular, L-lysine. When D- or L-lysine is selected, it is sufficient to use D- or L-lysine as the active ingredient, but concurrent use of L- or D-lysine is not precluded. In such a case, the concurrently used L- or D-lysine (i.e., the one not selected as the active ingredient) shall not be considered as the active ingredient (i.e., it shall be regarded as an ingredient that is not the active ingredient).

As lysine, a commercially available product or one obtained by appropriately produced may be used. The method for producing lysine is not particularly limited. Lysine may be produced by, for example, known methods. Specifically, lysine may be produced by chemical synthesis, enzymatic reaction, fermentation, extraction, or a combination thereof. Lysine may or may not be purified to a desired degree. That is, lysine may be a purified product or a material containing lysine. Specific examples of materials containing lysine include fermentation products such as culture broth obtained by culturing a microorganism capable of producing lysine, cells of such a microorganism, and culture supernatant similarly obtained; agricultural, aquatic and livestock products containing lysine; and processed products thereof. Examples of such processed products include those obtained by subjecting materials such as the aforementioned fermentation products to such a process as concentration, dilution, drying, fractionation, extraction, and purification. As lysine, a material having a lysine content of 1% (w/w) or higher, 5% (w/w) or higher, 10% (w/w) or higher, 30% (w/w) or higher, 50% (w/w) or higher, 70% (w/w) or higher, 90% (w/w) or higher, or 95% (w/w) or higher may be used.

### (3) Yeast Extract

The term “yeast extract” may mean an extract of yeast. The form of the yeast extract is not particularly limited. The yeast extract may be in any form, such as liquid, powder, paste, etc. The type of yeast is not particularly limited. Examples of yeast include Saccharomyces yeasts such as Saccharomyces cerevisiae, Schizosaccharomyces yeasts such as Schizosaccharomyces pombe, and Candida yeasts such as Candida utilis. Saccharomyces yeasts and Candida yeasts, in particular, can be mentioned as examples of yeast.

The yeast extract may contain γ-Glu-Abu. Yeast extract containing γ-Glu-Abu is also referred to as γ-Glu-Abu-containing yeast extract. Such γ-Glu-Abu-containing yeast extract may be obtained from, for example, the yeast containing γ-Glu-Abu mentioned above. The content of γ-Glu-Abu in γ-Glu-Abu-containing yeast extract may be, for example, 1% (w/w) or higher, 3% (w/w) or higher, 5% (w/w) or higher, 7% (w/w) or higher, 10% (w/w) or higher, 15% (w/w) or higher, 20% (w/w) or higher, 25% (w/w) or higher, or 30% (w/w) or higher, and may be 50% (w/w) or lower, 45% (w/w) or lower, 40% (w/w) or lower, 30% (w/w) or lower, 20% (w/w) or lower, 15% (w/w) or lower, 13% (w/w) or lower, or 10% (w/w) or lower, based on the dry weight of γ-Glu-Abu-containing yeast extract, or within a rage defined by any non-contradictory combination of these minimum and maximum contents. The γ-Glu-Abu content in the γ-Glu-Abu-containing yeast extract may specifically be, for example, 1 to 30% (w/w), 3 to 20% (w/w), 5 to 15% (w/w), or 7 to 13% (w/w), based on the dry weight of the γ-Glu-Abu-containing yeast extract. As the yeast extract, one type of yeast extract may be used, one type of γ-Glu-Abu-containing yeast extract may be used, or two or more types of yeast extract and/or γ-Glu-Abu-containing yeast extract may be used in combination.

The yeast extract may not contain γ-Glu-Abu. The expression that the yeast extract does not contain γ-Glu-Abu also means that the yeast extract does not substantially contain γ-Glu-Abu. Specifically, the expression that the yeast extract does not contain γ-Glu-Abu may mean that, for example, the content of γ-Glu-Abu in the yeast extract is lower than 1% (w/w), lower than 0.1% (w/w), or lower than 0.01% (w/w), based on the dry weight of the yeast extract.

When the yeast extract contains γ-Glu-Abu, γ-Glu-Abu contained in the yeast extract may be regarded as an ingredient corresponding to “γ-Glu-Abu or a salt thereof” in the active ingredient, and ingredients other than γ-Glu-Abu in the yeast extract may be regarded as ingredients corresponding to the “yeast extract” in the active ingredient. As the yeast extract, a commercially available product or one obtained by appropriately produced may be used. The method for producing yeast extract is not particularly limited. The yeast extract may be produced by, for example, known methods. Specifically, the yeast extract may be produced by, for example, processing yeast into yeast extract. Processing of yeast into yeast extract may be achieved by, for example, autolysis, acidolysis, enzymolysis, or a combination thereof.

When the active ingredient can form a salt, the active ingredient (for example, each of γ-Glu-Abu and lysine) may be utilized as a free compound, a salt, or a mixture thereof. That is, the term “active ingredient” may mean the active ingredient in free form, a salt thereof, or a combination thereof, unless especially noted. Further, the term “active ingredient or a salt thereof” may mean either one or both of the active ingredient in free form and a salt thereof, in other words, the active ingredient in free form, a salt thereof, or a combination thereof. The term “free form” means a form not forming a salt. Further, when the active ingredient can form a hydrate, the active ingredient may be used as a non-hydrate, hydrate, or a combination thereof. That is, the term “active ingredient” (e.g., “active ingredient in free form” or “salt of the active ingredient”) may include non-hydrates and hydrates, unless especially noted. The active ingredient may exist in any form, such as in the form of ion, at the time of use. These descriptions regarding the form of the active ingredient may also apply to ingredients other than the active ingredient.

The salt is not particularly limited as long as it is orally ingestible. For example, salts for acidic groups such as carboxyl group include, specifically, ammonium salts, salts with alkali metal such as sodium and potassium, salts with alkaline earth metal such as calcium and magnesium, aluminum salts, zinc salts, and salts with organic amines such as triethylamine, ethanolamine, morpholine, pyrrolidine, piperidine, piperazine, and dicyclohexylamine. Further, specific examples of salts for basic groups such as amino group include salts with inorganic acids such as hydrochloric acid, sulfuric acid, phosphoric acid, nitric acid, and hydrobromic acid, salts with organic carboxylic acids such as acetic acid, citric acid, benzoic acid, maleic acid, fumaric acid, tartaric acid, succinic acid, tannic acid, butyric acid, hibenzic acid, pamoic acid, enanthic acid, decanoic acid, theoclic acid, salicylic acid, lactic acid, oxalic acid, mandelic acid, malic acid, methylmalonic acid, and adipic acid, and salts with organic sulfonic acids such as methanesulfonic acid, benzenesulfonic acid, and p-toluenesulfonic acid. Specific examples of salts of lysine include, for example, lysine hydrochloride. As the salt, one type of salt may be used, or two or more types of salts may be used in combination.

When a material containing the active ingredient is utilized, the amount of the active ingredient (e.g., content (concentration) or amount used) shall be calculated on the basis of the amount of the active ingredient itself contained in the material. Further, when the active ingredient is in the form of a salt or hydrate, the amount of the active ingredient (e.g., content (concentration) or amount used) shall be calculated based on a value converted from the mass of the salt or hydrate to the mass of the equimolar, non-hydrated free form. Further, the amount of yeast extract (e.g., content (concentration) or amount used) shall be calculated on the basis of dry weight of the yeast extract.

### <2> Composition of the Present Invention

The composition of the present invention is a composition containing the active ingredient.

That is, the composition of the present invention is a composition containing γ-Glu-Abu and lysine.

The composition of the present invention may be read as a composition containing γ-Glu-Abu or a salt thereof and lysine or a salt thereof.

The composition of the present invention may further contain yeast extract.

By utilizing the composition of the present invention, eating quality of foods can be improved. That is, an eating quality-improving effect can be obtained. Therefore, the composition of the present invention may be utilized to improve eating quality of foods. That is, the composition of the present invention may be, for example, a composition for improving eating quality of a food. The improvement of eating quality may be, for example, enhancement of livestock-meat-like sensation, impartation of kokumi, impartation of meat flavor, and/or impartation of oil or fat flavor. The improvement of eating quality may be, in particular, enhancement of livestock-meat-like sensation and/or impartation of kokumi. The impartation of kokumi may be impartation of initial taste kokumi, mid-taste kokumi, aftertaste kokumi, or a combination thereof. The impartation of kokumi may be, in particular, impartation of not only initial taste kokumi but also mid-taste and aftertaste kokumi.

Furthermore, by utilizing the composition of the present invention, foods with improved eating quality can be produced. Therefore, the composition of the present invention may be utilized in food production (specifically, production of foods with improved eating quality). That is, the composition of the present invention may be, for example, a composition for production of foods (specifically, for production of foods with improved eating quality).

The composition of the present invention may be, for example, a seasoning. Specifically, the composition of the present invention may be, for example, a seasoning for improving eating quality of foods, and may be a seasoning for production of foods (specifically, for production of foods with improved eating quality).

The composition of the present invention itself may or may not have an improved eating quality on its own. For example, the composition of the present invention itself may have an enhanced (including imparted, as defined above) livestock-meat-like sensation on its own (specifically, enhanced livestock-meat-like sensation compared with that of those not containing the active ingredient).

The composition of the present invention may be utilized for improving eating quality or production of foods in the manners described in the section of the method of the present invention described below.

The composition of the present invention may consist of the active ingredient or may contain ingredients other than the active ingredient. The ingredients other than the active ingredient may be a single kind of ingredient or a combination of two or more kinds of ingredients.

The active ingredient contained in the composition of the present invention may be produced by the methods for producing the active ingredient described above. Therefore, the method for producing the composition of the present invention may include the step of producing the active ingredient by the method for producing the active ingredient described above.

The ingredients other than the active ingredient are not particularly limited as long as they do not impair the eating quality-improving effect (i.e., the eating quality-improving effect provided by the active ingredient can be obtained). The ingredients other than the active ingredient can be appropriately selected according to various conditions, such as the type of food. The ingredients other than the active ingredient include ingredients blended into foods or pharmaceuticals. Specific examples of the ingredients other than the active ingredient include, for example, raw materials derived from livestock meat, more specifically, raw materials or livestock meat extracts derived from beef, and even more specifically, beef extract can be mentioned.

As the ingredients other than the active ingredient, specifically, ingredients effective for food production can be mentioned. The ingredients effective for food production include the raw materials of foods described later.

As the ingredients other than the active ingredient, a single kind of ingredient may be used, or two or more ingredients may be used in combination.

The composition of the present invention can be produced by, for example, appropriately mixing the active ingredient and optionally other ingredients.

The composition of the present invention may be, for example, appropriately formulated in the form of a preparation. For formulating the composition, additives may be utilized as appropriate. Examples of additives include excipients, binders, disintegrants, lubricants, stabilizers, flavor and odor correctors, diluents, surfactants, and solvents. Such additives may be selected as appropriate depending on various conditions, such as the shape of the composition of the present invention.

The shape of the composition of the present invention is not particularly limited. The composition of the present invention may be in any shape, such as powder, flakes, tablets, paste, and liquid.

The contents and content ratio of respective ingredients (i.e., the active ingredient and optionally other ingredients) in the composition of the present invention are not particularly limited as long as the eating quality-improving effect can be obtained. The contents and content ratio of respective ingredients in the composition of the present invention can be appropriately set depending on various conditions such as the manner of use of the composition of the present invention.

The total content of the active ingredient in the composition of the present invention is higher than 0% (w/w) and lower than or equal to 100% (w/w). The total content of the active ingredient in the composition of the present invention may be, for example, 1% (w/w) or higher, 2% (w/w) or higher, 5% (w/w) or higher, 10% (w/w) or higher, or 20% (w/w) or higher, and may be 100% (w/w) or lower, 99.9% (w/w) or lower, 50% (w/w) or lower, 20% (w/w) or lower, 10% (w/w) or lower, 5% (w/w) or lower, or may be in any range defined by a non-contradictory combination of these maximum and minimum contents.

The content ratio of γ-Glu-Abu or a salt thereof and lysine or a salt thereof in the composition of the present invention is not particularly limited as long as the eating quality-improving effect can be obtained. The content ratio of γ-Glu-Abu and lysine in the composition of the present invention may be, for example, 100:1 to 1:1000, 10:1 to 1:100, 1:1 to 1:40, or 1:6 to 1:12 in terms of molar ratio. The content ratio of γ-Glu-Abu or a salt thereof and lysine or a salt thereof may be expressed as a ratio of mole numbers calculated from the number of γ-Glu-Abu molecules calculated from the total amount of γ-Glu-Abu and a salt thereof contained in the composition and the number of lysine molecules calculated from the total amount of lysine and a salt thereof contained in the composition, i.e., molar ratio.

The contents of the respective active ingredients in the composition of the present invention can be set so that, for example, the total content of the active ingredient and the content ratio of the active ingredient in the composition of the present invention described above are obtained.

The contents of the respective ingredients (i.e., active ingredient and optionally other ingredients) in the composition of the present invention may be set so that, for example, the amounts of the respective ingredients added in the method of the present invention described below are obtained.

The respective ingredients contained in the composition of the present invention (i.e., the active ingredient and optionally other ingredients) may be contained in the composition of the present invention as a mixture, or may be contained each separately or contained separately in any combination thereof in the composition of the present invention. For example, the composition of the present invention may be provided as a set of the respective ingredients of the active ingredient each packaged separately. In such a case, the ingredients included in the set may be used together as appropriate at the time of use.

### <3> Method of the Present Invention

The method of the present invention is a method comprising the step of utilizing the active ingredient.

Specifically, the method of the present invention comprises the step of utilizing γ-Glu-Abu and lysine.

The method of the present invention may be read as a method comprising the step of utilizing γ-Glu-Abu or a salt thereof and lysine or a salt thereof.

The method of the present invention may further comprise the step of utilizing yeast extract.

According to the method of the present invention, specifically by utilizing the active ingredient, eating quality of foods can be improved. That is, the eating quality-improving effect can be obtained. Therefore, the method of the present invention may be implemented for improving eating quality of foods. That is, the method of the present invention may be, for example, a method for improving eating quality of foods. This method is also referred to as “the eating quality-improving method of the present invention”. The improvement in eating quality may be, for example, enhancement of livestock-meat-like sensation, impartation of kokumi, impartation of meat flavor, and/or impartation of oil or fat flavor. The improvement in eating quality may be, in particular, enhancement of livestock-meat-like sensation and/or impartation of kokumi. The impartation of kokumi may be impartation of initial taste kokumi, mid-taste kokumi, aftertaste kokumi, or a combination thereof. In particular, the impartation of kokumi may be not only impartation of initial taste kokumi, but also impartation of mid-taste and aftertaste kokumi.

Further, according to the method of the present invention, specifically by utilizing the active ingredient, foods with improved eating quality can be produced. Therefore, the method of the present invention may be implemented for production of foods (specifically, production of foods with improved eating quality). That is, the composition of the present invention may also be a method for producing foods (specifically, for producing foods with improved eating quality). This method is also referred to as “the food production method of the present invention”.

The active ingredient can be utilized to improve eating quality or produce foods by adding it to food raw materials during food production. That is, examples of use of the active ingredient include adding the active ingredient to raw materials of foods. Thus, the method of the present invention may specifically be, for example, a method for improving eating quality of a food, comprising adding the active ingredient to food raw materials. Further, the method of the present invention may specifically be, for example, a method for producing foods (specifically, producing foods with improved eating quality), comprising adding the active ingredient to food raw materials. The term “adding” may also be referred to as “blending”.

The active ingredient may be utilized in the method of the present invention, for example, in the form of the composition of the present invention. That is, “use of the active ingredient” also includes use of the composition of the present invention. For example, “addition of the active ingredient” also includes addition of the composition of the present invention.

The food obtained by the method of the present invention is also referred to as “the food of the present invention”. Specifically, the food of the present invention is a food with improved eating quality. In other words, the food of the present invention is a food to which the active ingredient has been added.

The improvement of eating quality or the production of foods may be carried out, for example, in the same manner as the production of conventional foods, except for the use of the active ingredient. That is, the improvement in eating quality or the production of foods may be carried out by using the same raw materials under the same production conditions as those for conventional foods, except for the use of the active ingredient. Furthermore, raw materials and production conditions of foods may be appropriately modified and utilized for the improvement in eating quality or the production of foods.

The type of the food is not particularly limited, provided that it is a food for which improvement in eating quality is desired. The term food includes beverages. The term food also includes seasonings. The food may be liquid or solid. Specific examples of the food include: beverages such as milk, soft drinks, alcoholic beverages, and soups; processed meat products such as ham, sausage, gyoza, shumai, hamburg steak, fried chicken, and pork cutlet; processed fish products such as salmon flakes, spicy cod roe, salted cod roe, grilled fish, dried fish, salted fish, fish sausage, fish cake, simmered fish, tsukudani, and canned seafood products; snacks such as potato chips, potato snacks, corn snacks, wheat snacks, cinnamon cookies, non-glutinous rice crackers, and glutinous rice crackers; noodle sauces and dipping sauces such as udon broth, soba broth, somen broth, ramen soup, champon soup, and pasta sauce; rice dishes such as rice balls, pilaf, fried rice, mixed rice, rice porridge, and ochazuke; stewed dishes such as curry, stew, chili con carne, feijoada, and mapo tofu; roux such as stew roux, and curry roux; processed vegetables such as kimchi, and pickles; other processed foods such as bread, noodles, gratin, croquettes, and mashed potatoes; sauces such as Chinese sauce, oyster sauce, cheese sauce, tomato sauce, white sauce, demi-glace sauce, curry sauce, pesto sauce, chili sauce, and Tabasco sauce; flavored oils such as chili oil; basic seasonings such as soy sauce and miso; flavor seasonings such as beef, chicken, pork, and bonito flavor seasonings; spicy seasonings such as shichimi togarashi, doubanjiang, and gochujang; menu-specific seasonings (specialized seasonings tailored to specific dishes); and other seasonings such as dressings, miso, mayonnaise, tomato ketchup, and consommé. The term “soft drink” may mean non-alcoholic beverages (beverages with an alcohol content lower than 1%) excluding milk and dairy products. Specific examples of soft drink include water, fruit juices, vegetable juices, teas (chai, cinnamon tea, etc.), coffee beverages (coffee, coffee-flavored milk drinks, etc.), carbonated beverages (ginger ale, lemon soda, etc.), and sports drinks. Specific examples of soup include consommé soup, potage soup, Chinese-style soup, egg drop soup, curry-flavored soup, dal soup, tom yum kung, wakame soup, shark fin soup, Japanese clear soup, and miso soup. The food includes, in particular, those with meat flavors such as beef flavor, chicken flavor, and pork flavor. Specifically, the food includes, in particular, foods containing ingredients derived from livestock meat (e.g., the foods exemplified above that contain ingredients derived from livestock meat), more specifically, foods containing beef extract (e.g., the foods exemplified above that contain beef extract). Further, the food includes those that inherently contain ingredients derived from livestock meat, but contain a reduced amount of such ingredients as a result of replacing them with the active ingredient of the present invention. The food may be provided in a form ready for eating as is, or in a form requiring preparation before or during eating, such as concentrates or dried products. Further, the food is not limited to general foods, but also encompasses so-called health foods or medical foods, such as nutritional supplements, foods with nutrient function claims, and foods for specified health uses. That is, for example, the foods exemplified above may be provided as general foods, or as health foods or medical foods.

The term “raw material of food (food raw material)” refers to food materials utilized for producing foods. Such food raw materials are not particularly limited as long as foods can be produced from them. Food raw materials can be appropriately selected according to various conditions, such as type of the food. Examples of food raw materials include those typically utilized in the production of the foods exemplified above. Specific examples of food raw materials include: livestock meat extracts such as beef extract, pork extract, and chicken extract; ingredients such as meat, grains, vegetables, seafood, and eggs; seasoning ingredients such as sugars, inorganic salts, organic acids, nucleic acids, amino acids, and protein hydrolysates; dairy products such as milk and cheese; spices; flavorings; fats and oils; and alcohols. More specifically, examples of food raw materials include raw materials derived from livestock meat. In the present invention, “raw material derived from livestock meat” may mean a raw material derived from livestock without any restriction, which is not limited to raw materials derived from parts typically utilized as edible meat, but also includes raw materials derived from parts not typically utilized as edible meat, such as bones, skins, and internal organs. In the present invention, livestock includes cattle, pigs, chickens, sheep, goats, horses, etc., and cattle are preferred. In the present invention, livestock meat-derived raw materials include, for example, livestock-derived extracts, namely, livestock meat extracts, meat obtained from livestock (including dried meat and smoked meat), fats and oils, bone meal, etc. Among livestock-derived extracts, extracts derived from cattle are also called beef extracts, extracts derived from pigs are also called pork extracts, and extracts derived from chickens are also called chicken extracts.

The active ingredient may be added to the food raw material at any stage of production process of the food, provided that the eating quality-improving effect can be obtained. That is, the “food raw material” to which the active ingredient is added may be one at any stage of the production process of the food. For example, the “food raw material” to which the active ingredient is added may be a finished food product prior to the addition of the active ingredient. The active ingredient may be added to the food raw material either as is or prepared into a desired form, such as a solution, as appropriate, and added. The term “addition of the active ingredient” may be broadly defined as any operation that brings the active ingredient into coexistence with the food raw material. When two or more types of ingredients are used as the active ingredient, the description regarding the addition of the active ingredient applies independently to each active ingredient, unless especially noted. When two or more types of ingredients are used as the active ingredient, they all may be added simultaneously to the food raw material, or they may be added separately, or separately in any combination thereof, to the food raw material. When two or more types of ingredients are used as the active ingredient, the order in which the respective active ingredients are added to the food raw material is not particularly limited.

The addition amounts and ratios of respective ingredients (i.e., the active ingredient and optionally other ingredients) in the method of the present invention are not particularly limited as long as the eating quality-improving effect can be obtained. The addition amounts and ratios of respective ingredients used in the method of the present invention can be appropriately set according to various conditions such as the type of food raw material and the type of food.

The active ingredient may be added to the food raw material so that, for example, the concentration of the active ingredient at the time of eating falls within the desired range.

The concentration at the time of eating of γ-Glu-Abu or a salt thereof may be, for example, 0.00001 ppm (w/w) or higher, 0.0001 ppm (w/w) or higher, 0.001 ppm (w/w) or higher, 0.01 ppm or higher, 0.1 ppm (w/w) or higher, 0.5 ppm (w/w) or higher, or 1 ppm (w/w) or higher, and may be 1000 ppm (w/w) or lower, 100 ppm (w/w) or lower, 10 ppm (w/w) or lower, 5 ppm (w/w) or lower, 1 ppm (w/w) or lower, or 0.5 ppm (w/w) or lower, or may be within any range defined by a non-contradictory combination of these maximum and minimum concentrations. The concentration at the time of eating of γ-Glu-Abu or a salt thereof may specifically be, for example, 0.0001 ppm (w/w) or higher and 1000 ppm (w/w) or lower, 0.01 ppm (w/w) or higher and 1000 ppm (w/w) or lower, 0.1 ppm (w/w) or higher and 100 ppm (w/w) or lower, 0.5 ppm (w/w) or higher and 100 ppm (w/w) or lower, or 1 ppm (w/w) or higher and 100 ppm (w/w) or lower.

The concentration at the time of eating of lysine or a salt thereof may be, for example, 0.001 ppm (w/w) or higher, 0.01 ppm (w/w) or higher, 0.1 ppm (w/w) or higher, 1 ppm (w/w) or higher, 3 ppm (w/w) or higher, or 10 ppm (w/w) or higher, and may be 1000 ppm (w/w) or lower, 100 ppm (w/w) or lower, 10 ppm (w/w) or lower, or 5 ppm (w/w) or lower, or may be within any range defined by a non-contradictory combination of these maximum and minimum concentrations. The concentration at the time of eating of lysine or a salt thereof may specifically be, for example, 0.01 ppm (w/w) or higher and 1000 ppm (w/w) or lower, 0.1 ppm (w/w) or higher and 1000 ppm (w/w) or lower, 1 ppm (w/w) or higher and 1000 ppm (w/w) or lower, or 3 ppm (w/w) or higher and 1000 ppm (w/w) or lower.

The concentration at the time of eating of yeast extract, in terms of dry weight of yeast extract, may be, for example, 0.0001 ppm (w/w) or higher, 0.001 ppm (w/w) or higher, 0.01 ppm (w/w) or higher, 0.1 ppm or higher, 1 ppm (w/w) or higher, 5 ppm (w/w) or higher, or 10 ppm (w/w) or higher, and may be 10,000 ppm (w/w) or lower, 1,000 ppm (w/w) or lower, 100 ppm (w/w) or lower, 50 ppm (w/w) or lower, 10 ppm (w/w) or lower, or 5 ppm (w/w) or lower, or may be within any range defined by a non-contradictory combination of these maximum and minimum concentrations. The concentration at the time of eating of yeast extract, in terms of dry weight of yeast extract, may be, for example, 0.001 ppm (w/w) or higher and 10,000 ppm (w/w) or lower, 0.1 ppm (w/w) or higher and 10,000 ppm (w/w) or lower, 1 ppm (w/w) or higher and 1,000 ppm (w/w) or lower, 5 ppm (w/w) or higher and 1,000 ppm (w/w) or lower, or 10 ppm (w/w) or higher and 1,000 ppm (w/w) or lower.

The descriptions concerning the addition of the active ingredient is also applicable to addition of the composition of the present invention. For example, the composition of the present invention can be added so that the addition amount of the active ingredient exemplified above can be obtained.

The food of the present invention may contain a raw material derived from livestock meat in addition to the active ingredient, or may not contain such a raw material derived from livestock meat. The food of the present invention may be a food having a livestock meat-derived raw material content at a certain level or lower (e.g., within the content range described below). In this case, the livestock meat-derived raw material may refer only to livestock meat extract. That is, the food of the present invention may contain livestock meat extract, or may not contain livestock meat extract, in addition to the active ingredient. The food of the present invention may be a food having a livestock meat extract content at a certain level or lower (e.g., within the content range described later). Further, in this case, the livestock meat extract may refer only to beef extract. That is, the food of the present invention may contain beef extract, or may not contain beef extract, in addition to the active ingredient. The food of the present invention may be a food having a beef extract content at a certain level or lower (e.g., within the content range described later).

The content of the livestock meat-derived raw material, livestock meat extract, or beef extract in the food of the present invention is not particularly limited, and may be appropriately set according to various conditions such as the type of the food. However, it may be at a certain level or lower, for example, 20% (w/w) or lower, 15% (w/w) or lower, 10% (w/w) or lower, 5% (w/w) or lower, 3% (w/w) or lower, 1% (w/w) or lower, or 0.1% (w/w) or lower. The minimum content of the livestock meat-derived raw material, livestock meat extract, or beef extract in the food of the present invention is not particularly limited and may be 0% (w/w), i.e., the food may not contain it. The food of the present invention may specifically be, for example, a food that does not contain a livestock meat-derived raw material or contains livestock meat-derived raw material at a content of 10% (w/w) or lower, a food that does not contain livestock meat extract or contains livestock meat extract at a content of 10% (w/w) or lower, or a food that does not contain beef extract or contains beef extract at a content of 10% (w/w) or lower.

Further, the food of the present invention may be a food with a reduced content of livestock meat-derived raw material. The term “food with a reduced content of livestock meat-derived raw material” means a food with a lower content of livestock meat-derived raw material than usual (i.e., a food with a content of livestock meat-derived raw material lower than the usual content of livestock meat-derived raw material). A food containing a usual amount of livestock meat-derived raw material (i.e., food with a usual content of livestock meat-derived raw material) is also referred to as “conventional livestock meat-based food”. That is, such a “food with a reduced content of livestock meat-derived raw material” may specifically mean a food with a reduced content of livestock meat-derived raw material compared with a conventional livestock meat-based food of the same type. More specifically, the “food with a reduced content of meat-derived raw material” may mean a food with a content of meat-derived raw material 0.9 times or lower, 0.8 times or lower, 0.7 times or lower, 0.6 times or lower, or 0.5 times or lower of that of a conventional livestock meat-based food of the same type, or it may mean a food that does not substantially contain livestock meat-derived raw material. The terms “content of livestock meat-derived raw material” and “concentration of livestock meat-derived raw material” may be used interchangeably. Examples of the food with a reduced content of livestock meat-derived raw material include foods such as the foods exemplified above, produced to have a lower content of livestock meat-derived raw material than usual. Examples of the conventional livestock meat-based foods include foods such as those exemplified above, produced to have the usual contents of livestock meat-derived raw material. The term food with a reduced content of “livestock meat-derived raw material” may be read as food with a reduced content of “livestock meat extract” or food with a reduced content of “beef extract”.

In other words, “reducing livestock meat-derived raw material in a food” means lowering the livestock meat-derived raw material content in the food below the usual livestock meat-derived raw material content in conventional livestock meat-derived foods. Specifically, “reducing livestock meat-derived raw materials in a food” may mean lowering the livestock meat-derived raw material content in the food below the livestock meat-derived raw material content in the conventional livestock meat-derived food of the same type. More specifically, “reducing livestock meat-derived raw material in a food” may mean reducing the content of livestock meat-derived raw material in the food to 0.9 times or lower, 0.8 times or lower, 0.7 times or lower, 0.6 times or lower, or 0.5 times or lower of the livestock meat-derived raw material content in the conventional livestock meat-based food of the same type, or may mean to produce the food so as not to substantially contain livestock meat-derived raw material. The reduction of “livestock meat-derived raw material” in a food may be read as reduction of “meat extract” in the food or reduction of “beef extract” in the food. Achieving one or more of the reduction of livestock meat-derived raw material in a food, reduction of livestock meat extract in a food, and reduction of beef extract in a food may be referred to as “reduction of livestock meat-derived raw material etc. in a food”.

Even when the food of the present invention is a food that contains livestock meat-derived raw material etc. (i.e., livestock meat-derived raw material, livestock meat extract, or beef extract) at a certain level or lower, does not contain livestock meat-derived raw material etc. or contains a reduced amount of livestock meat-derived raw material etc., if the food contains the active ingredient, the eating quality-improving effect can be obtained.

### <4> Use of Active Ingredient

The present invention also discloses use of the active ingredient for the purposes exemplified above. That is, the present invention discloses use of the active ingredient for, for example, improving eating quality, reducing raw materials derived from livestock meat in foods, or producing foods; and use of the active ingredient in the production of compositions for improving eating quality, reducing raw materials derived from livestock meat in foods, or producing foods.

The present invention also discloses the active ingredient for use in the applications exemplified above. That is, the present invention discloses the active ingredient for use in, for example, improving eating quality, reducing raw materials derived from livestock meat in foods, or producing foods, and the active ingredient for use in production of compositions for improving eating quality, reducing raw materials derived from livestock meat in foods, or producing foods.

The present invention also discloses use of the respective ingredients of the active ingredient in combination with other active ingredients. The respective ingredients of the active ingredient may be used in combination with other active ingredients for the purposes exemplified above.

### EXAMPLES

Hereafter, the present invention will be explained further specifically with reference to non-limiting examples.

The high γ-Glu-Abu content yeast extract used in this example is a powdered yeast extract containing 7 to 13% (w/w) of γ-Glu-Abu in terms of dry weight, prepared according to the method described in International Publication WO2012/046731. The lysine hydrochloride used in this example is L-lysine hydrochloride.

The raw materials were weighed according to the blending ratios shown in Table 1, and mixed as powder in a mortar, then hard fat heated to 70° C. using a hot stirrer was added, and the mixture was stirred until the whole mixture became uniform to prepare a seasoning. Then, 1.8 g of this seasoning was dissolved in 100 mL of hot water to prepare a base. Madras curry powder was the product of the same name produced by House Foods Corporation. Hydrogenated palm oil with a melting point of 45 to 50° C. was used.

TABLE 1
Blending ratios of raw materials in seasoning

| | Blending |
|---|---|
| Raw material | ratio (%) |
| Sodium chloride | 41.5 |
| Sodium glutamate | 11.9 |
| Sodium inosinate | 0.9 |
| Granulated sugar | 14.3 |
| Citric acid | 0.4 |
| Lactose | 24.2 |
| Madras curry powder | 2.3 |
| Hydrogenated palm oil | 4.5 |

### Example 1

The effect of combined use of γ-Glu-Abu and lysine for enhancing kokumi was evaluated. The ingredients listed in Table 2 were added to the aforementioned base at the concentrations at the time of eating indicated in the table to prepare samples for Test #1 to #6. For each sample, initial taste kokumi and mid-taste to aftertaste kokumi were evaluated by a sensory evaluation conducted by a panel of experts. The initial taste kokumi and mid-taste to aftertaste kokumi were defined as kokumi felt within 0 to 1 second and 1 to 5 seconds after eating (after the food or beverage was taken into the mouth), respectively. The evaluation results were represented with sensory evaluation scores of 9-point scale from 1 to 9, for which evaluation criteria were as follows. A higher score indicates a greater effect on enhancing kokumi.
Evaluation score 1: No difference compared with the additive-free base
Evaluation score 3: Slightly stronger than the additive-free base
Evaluation score 6: Stronger than the additive-free base
Evaluation score 9: Markedly stronger than the additive-free base

The results are shown in Table 2. When γ-Glu-Abu, γ-Glu-Abu high content yeast extract, or lysine hydrochloride were added individually, slight improvements in initial taste kokumi and mid-taste to aftertaste kokumi were observed compared with the base (#1), but no marked kokumi-enhancing effect was achieved (#2 to #4). However, when γ-Glu-Abu and lysine hydrochloride, or γ-Glu-Abu high content yeast extract and lysine hydrochloride were added in combination (#5 and #6), a marked kokumi-imparting and enhancing effects were observed for initial taste kokumi and mid-taste to aftertaste kokumi compared with the base (#1). Further, addition of γ-Glu-Abu and lysine hydrochloride or γ-Glu-Abu high content yeast extract and lysine hydrochloride in combination (#5 and #6) yielded synergistic rather than additive improvements in evaluation scores compared with addition of each ingredient alone (#2 to #4). From the above, it became clear that the combined use of γ-Glu-Abu or yeast extract with a high γ-Glu-Abu content and lysine is important for enhancing kokumi.

TABLE 2

| | Test No. | | | | | |
|---|---|---|---|---|---|---|
| | #1 | #2 | #3 | #4 | #5 | #6 |
| γ-Glu-Abu (ppm) | — | 0.5 | — | — | 0.5 | — |
| γ-Glu-Abu high content yeast | — | — | 5.0 | — | — | 5.0 |
| extract (ppm) | | | | | | |
| Lysine hydrochloride (ppm) | — | — | — | 3.0 | 3.0 | 3.0 |
| Initial taste kokumi | 1 | 4 | 3 | 3 | 6 | 8 |
| Mid-taste to aftertaste | 1 | 3 | 4 | 2 | 7 | 9 |
| kokumi | | | | | | |

### Example 2

Then, comparisons with other peptide and amino acids were conducted. As the other peptide, glutamylvalylglycine (γ-Glu-Val-Gly), for which kokumi-enhancing effect has been reported, was used. As other amino acids, arginine and sodium aspartate were used. The ingredients shown in Table 3 were added to the base mentioned above at the concentrations at the time of eating indicated in the table to prepare samples for Tests #7 to #13. For each sample, initial taste kokumi and mid-taste to aftertaste kokumi were evaluated by a sensory evaluation conducted by a panel of experts using the same criteria as in Example 1.

The results are shown in Table 3. The combinations of γ-Glu-Val-Gly with lysine hydrochloride and γ-Glu-Abu with arginine or sodium aspartate did not yield any marked kokumi-enhancing effect (Tests #11 to 13). Therefore, it was suggested that the kokumi-enhancing effect is a characteristic effect of the combined use of γ-Glc-Abu and lysine.

TABLE 3

| | Test No. | | | | | | |
|---|---|---|---|---|---|---|---|
| | #7 | #8 | #9 | #10 | #11 | #12 | #13 |
| γ-Glu-Abu (ppm) | — | 0.5 | 0.5 | — | — | 0.5 | 0.5 |
| γ-Glu-Abu high content yeast | — | — | — | 5.0 | | — | — |
| extract (ppm) | | | | | | | |
| γ-Glu-Val-Gly (ppm) | — | — | — | — | 0.5 | — | — |
| Lysine hydrochloride (ppm) | — | — | 3.0 | 3.0 | 3.0 | — | — |
| Arginine (ppm) | — | — | — | — | — | 3.0 | — |
| Sodium aspartate (ppm) | — | — | — | — | — | — | 3.0 |
| Initial taste kokumi | 1 | 4 | 6 | 8 | 5 | 4 | 4 |
| Mid-taste to aftertaste kokumi | 1 | 3 | 7 | 9 | 5 | 5 | 5 |

### Example 3

The addition amounts of γ-Glu-Abu and lysine were examined. The ingredients shown in Tables 4 and 5 were added to the aforementioned base at the concentrations at the time of eating indicated in the tables to prepare samples for Tests #14 to #29. For each sample, initial taste kokumi and mid-taste to aftertaste kokumi were evaluated by a sensory evaluation conducted by a panel of experts using the same criteria as in Example 1.

The results of examining the addition amount of γ-Glu-Abu are shown in Table 4. When γ-Glu-Abu was used in combination with lysine, it exhibited kokumi-enhancing effect at concentrations at the time of eating of 0.0001 ppm or higher, and yielded a marked kokumi-enhancing effect, in particular, at concentrations at the time of eating of 0.01 ppm or higher (#15 to #21).

TABLE 4

| | Test No. | | | | | | | |
|---|---|---|---|---|---|---|---|---|
| | #14 | #15 | #16 | #17 | #18 | #19 | #20 | #21 |
| γ-Glu-Abu (ppm) | — | 0.0001 | 0.001 | 0.01 | 0.1 | 1 | 10 | 100 |
| Lysine hydrochloride (ppm) | 3 | 3 | 3 | 3 | 3 | 3 | 3 | 3 |
| Initial taste kokumi | 3 | 4 | 4 | 5 | 6 | 8 | 9 | 9 |
| Mid-taste to aftertaste kokumi | 2 | 3 | 4 | 5 | 7 | 8 | 9 | 9 |

The results of examining the addition amount of lysine hydrochloride are shown in Table 5. Lysine hydrochloride showed kokumi-enhancing effect at concentrations at the time of eating of 0.01 ppm or higher when used in combination with γ-Glu-Abu, and yielded a marked kokumi-enhancing effect, in particular, at concentrations at the time of eating of 0.1 ppm or higher (#23 to 29).

TABLE 5

| | Test No. | | | | | | | |
|---|---|---|---|---|---|---|---|---|
| | #22 | #23 | #24 | #25 | #26 | #27 | #28 | #29 |
| γ-Glu-Abu (ppm) | 0.5 | 0.5 | 0.5 | 0.5 | 0.5 | 0.5 | 0.5 | 0.5 |
| Lysine hydrochloride (ppm) | — | 0.001 | 0.01 | 0.1 | 1 | 10 | 100 | 1000 |
| Initial taste kokumi | 4 | 4 | 4 | 5 | 6 | 6 | 7 | 7 |
| Mid-taste to aftertaste kokumi | 3 | 3 | 4 | 5 | 7 | 8 | 9 | 9 |

The effect of combined use of γ-Glu-Abu and lysine for enhancing beef-extract-like sensation was evaluated. The ingredients listed in Table 6 were added to the aforementioned base at the concentrations at the time of eating indicated in the table to prepare samples for Test #30 to #36. Beef extract A-1799 (produced by Nikken Foods Co., Ltd.) was used as the beef extract. For each sample, beef-extract-like sensation in initial taste and beef-extract-like sensation in mid-taste to aftertaste were evaluated by a sensory evaluation conducted by a panel of experts. The beef-extract-like sensation in initial taste and beef-extract-like sensation in mid-taste to aftertaste were defined as beef-extract-like sensation felt within 0 to 1 second and 1 to 5 seconds after eating (after the food or beverage was taken into the mouth), respectively. The evaluation results were represented with sensory evaluation scores of 9-point scale from 1 to 9, for which evaluation criteria were as follows. A higher evaluation score indicates a greater effect on enhancing beef-extract-like sensation.
Evaluation score 1: No difference compared with the additive-free base
Evaluation score 3: Slightly stronger than the additive-free base
Evaluation score 6: Stronger than the additive-free base
Evaluation score 9: markedly stronger than the additive-free base

The results are shown in Table 6. Additions of combinations of γ-Glu-Abu and lysine hydrochloride and γ-Glu-Abu high content yeast extract and lysine hydrochloride imparted beef-extract-like sensation. Further, even without addition of beef extract, additions of combinations of γ-Glu-Abu and lysine hydrochloride and γ-Glu-Abu high content yeast extract and lysine hydrochloride (#35 and #36) enhanced beef-extract-like sensation in a greater degree compared with the addition of beef extract alone (#31 and #32). Therefore, a marked beef-extract-like sensation-enhancing effect can be obtained by the combined use of γ-Glu-Abu and lysine.

TABLE 6

| | Test No. | | | | | | |
|---|---|---|---|---|---|---|---|
| | #30 | #31 | #32 | #33 | #34 | #35 | #36 |
| Beef extract (ppm) | — | 126.0 | 63.0 | — | — | — | — |
| γ-Glu-Abu (ppm) | — | — | — | 0.5 | — | 0.5 | — |
| γ-Glu-Abu high | — | — | — | — | 5.0 | — | 5.0 |
| content yeast | | | | | | | |
| extract (ppm) | | | | | | | |
| Lysine | — | — | — | — | — | 3.0 | 3.0 |
| hydrochloride (ppm) | | | | | | | |
| Initial taste | 1 | 4 | 2 | 3 | 2 | 6 | 7 |
| beef-extract-like | | | | | | | |
| sensation | | | | | | | |
| Mid-taste to | 1 | 4 | 2 | 2 | 3 | 4 | 7 |
| aftertaste | | | | | | | |
| beef-extract-like | | | | | | | |
| sensation | | | | | | | |

According to the present invention, eating quality of foods can be improved. Improving eating quality of foods is useful, for example, to compensate for the deterioration in eating quality caused by reducing livestock meat-derived raw materials.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

What is claimed is:

1. A composition comprising γ-glutamyl-2-aminobutyric acid (γ-Glu-Abu) or a salt thereof and lysine or a salt thereof.

2. The composition according to claim 1, wherein the lysine or a salt thereof is lysine hydrochloride.

3. The composition according to claim 1, wherein γ-Glu-Abu or a salt thereof is contained in yeast extract.

4. The composition according to claim 1, wherein said composition further comprises yeast extract.

5. The composition according to claim 1, wherein said composition comprises γ-Glu-Abu or a salt thereof and lysine or a salt thereof at a molar ratio of 10:1 to 1:100.

6. The composition according to claim 1, wherein said composition comprises γ-Glu-Abu or a salt thereof and lysine or a salt thereof at a molar ratio of 1:1 to 1:40.

7. The composition according to claim 1, wherein said composition comprises γ-Glu-Abu or a salt thereof and lysine or a salt thereof at a molar ratio of 1:6 to 1:12.

8. A method for improving eating quality of a food, comprising
the step of adding γ-glutamyl-2-aminobutyric acid (γ-Glu-Abu) or a salt thereof and lysine or a salt thereof to a raw material of the food.

9. A method for producing a food, comprising
the step of adding γ-glutamyl-2-aminobutyric acid (γ-Glu-Abu) or a salt thereof and lysine or a salt thereof to a raw material of the food.

10. The method according to claim 8, wherein the lysine or a salt thereof is lysine hydrochloride.

11. The method according to claim 8, wherein γ-Glu-Abu or a salt thereof is contained in yeast extract.

12. The method according to claim 8, further comprising the step of adding yeast extract to a raw material of the food.

13. The method according to claim 8, wherein the improving eating quality includes imparting or enhancing kokumi.

14. The method according to claim 8, wherein the food does not comprise livestock meat extract or comprises livestock meat extract at a content of 10% or lower.

15. The method according to claim 8, wherein γ-Glu-Abu or a salt thereof and lysine or a salt thereof are added at a molar ratio of 10:1 to 1:100.

16. The method according to claim 8, wherein γ-Glu-Abu or a salt thereof and lysine or a salt thereof are added at a molar ratio of 1:1 to 1:40.

17. The method according to claim 8, wherein γ-Glu-Abu or a salt thereof and lysine or a salt thereof are added at a molar ratio of 1:6 to 1:12.

18. The method according to claim 8,
wherein γ-Glu-Abu or a salt thereof is added so that final concentration of γ-Glu-Abu or a salt thereof in the food at the time of eating is 0.0001 ppm or higher and 1000 ppm or lower, and/or
wherein lysine or a salt thereof is added so that final concentration of lysine or a salt thereof in the food at the time of eating is 00.1 ppm or higher and 1000 ppm or lower.

19. A food comprising the composition according to claim 1.

20. The food according to claim 19, wherein the food does not comprise livestock meat extract or comprises livestock meat extract at a content of 10% or lower.
